(19) United States
(12) Patent Application Publication
(10) Pub. No.: US 2026/0091321 A1
(43) Pub. Date: Apr. 2, 2026

(54) SYSTEMS AND METHODS FOR GENERATING AN INTERACTIVE STORY ABOUT A DRIVING ENVIRONMENT USING A LEARNING MODEL

(71) Applicant: Toyota Jidosha Kabushiki Kaisha, Toyota-shi Aichi-ken (JP)

(72) Inventors: Tyler La Monda, Fairfield, CA (US); Alexander Charles Granieri, Mountain View, CA (US)

(21) Appl. No.: 18/902,256

(22) Filed: Sep. 30, 2024

(51) Int. Cl. A63G 31/02; G06N 3/08

(52) U.S. Cl. CPC A63G 31/02; G06N 3/08

(57) ABSTRACT

Systems, methods, and other embodiments described herein relate to generating and adjusting an interactive story about a driving environment using a learning model that factors trip features and an engagement factor. In one embodiment, a method includes acquiring sensor data from a vehicle, a contextual cue about occupants, and a preference associated with the occupants for a vehicle trip. The method also includes generating an interactive story and a driving environment that is virtual using a learning model from the sensor data, the contextual cue, and the preference. The method also includes adjusting the interactive story and the driving environment with augmented information using the learning model for display within the vehicle upon a comparison result of a parameter for the interactive story and the driving environment to an engagement factor being unsatisfied.

### TECHNICAL FIELD

The subject matter described herein relates, in general, to generating an interactive story about a driving environment, and, more particularly, to generating and adjusting the interactive story using the learning model according to features and engagement factors about a vehicle trip.

### BACKGROUND

Vehicles use sensor data that facilitate perceiving other vehicles, obstacles, pedestrians, and additional aspects of a surrounding environment. For example, a light detection and ranging (LIDAR) sensor uses light to scan the surrounding environment, while logic associated with the LIDAR analyzes acquired data to detect a presence of objects and other features of the surrounding environment. In further examples, cameras acquire information about the surrounding environment from which a system derives awareness about aspects of the surrounding environment. This sensor data can be useful in various circumstances for improving perceptions of the surrounding environment so that systems such as automated driving systems (ADS) can plan and navigate a vehicle trip safely.

Besides an ADS, systems can utilize environmental awareness about a vehicle to alter operator experiences and a vehicle trip. For instance, a navigation system utilizes traffic information derived from crowd-sourced data for rerouting the vehicle trip. Furthermore, audible sensors can measure road noise for adapting music volume when a vehicle travels on a highway and generates increased cabin noise. However, the systems can encounter challenges associated with augmenting operator experiences from incomplete sensor data involving a rapidly changing environment and personal traits about an operator being limited. Thus, systems relying upon environmental awareness for driving tasks that improve travel experience can exhibit decreased capabilities from limited and incomplete data.

### SUMMARY

In one embodiment, example systems and methods relate to generating and adjusting an interactive story about a driving environment using a learning model that factors trip features and an engagement factor. In various implementations, systems derive environmental awareness about a vehicle trip to augment and customize a vehicle experience for increasing travel pleasure. For example, an infotainment system and a navigation system generate a character voice as content when guiding an operator to follow a route during the vehicle trip. However, systems generating content can lack personalization about vehicle occupants and adaptation capabilities to maintain intrigue by the vehicle occupants. Furthermore, systems can also demand using a creation engine having additional computing resources that is disconnected from a vehicle when designing the content (e.g., a mobile phone) for complex trips (e.g., multiple stops). As such, systems generating content for travel pleasure can lack customization and dynamic features that hinder occupant interest.

Therefore, in one embodiment, an interactive system includes a tool for content creation within a vehicle using a learning model that links with various vehicle systems locally and data sources that are remote to the vehicle. Here, integrating the tool within the vehicle allows direct access to sensor systems, vehicle settings, etc., as inputs that feed the learning model for rapidly generating rich and engaging content. In one approach, the interactive system acquires occupant inputs and images from vehicle cameras about a surrounding environment and generatively crafts immersive and interactive narratives for a route taken during a vehicle trip automatically using the learning model (e.g., a data-driven model, a generative artificial intelligence (GenAI) model, etc.). The information allows personally tailoring a narrative to the preferences about vehicle occupants that increases engagement and trip satisfaction. In another approach, a display system on a windshield within the vehicle receives outputs from the learning model to augment and virtually alter multi-media content (e.g., views, music, etc.). In this way, the interactive system transforms road trips into captivating journeys that are unique and engaging experiences through vivid storytelling by blending real-time environmental cues and historical context using occupant preferences, thereby improving interest with the vehicle trip.

In one embodiment, an interactive system that generates and adjusts an interactive story about a driving environment using a learning model that factors trip features and an engagement factor is disclosed. The interactive system includes a memory including instructions that, when executed by a processor, cause the processor to acquire sensor data from a vehicle, a contextual cue about occupants, and a preference associated with the occupants for a vehicle trip. The instructions also include instructions to generate an interactive story and a driving environment that is virtual using a learning model from the sensor data, the contextual cue, and the preference.

The instructions also include instructions to adjust the interactive story and the driving environment with augmented information using the learning model for display within the vehicle upon a comparison result between a parameter of the interactive story and the driving environment and an engagement factor being unsatisfied.

In one embodiment, a non-transitory computer-readable medium for generating and adjusting an interactive story about a driving environment using a learning model that factors trip features and an engagement factor and including instructions that when executed by a processor cause the processor to perform one or more functions is disclosed. The instructions include instructions to acquire sensor data from a vehicle, a contextual cue about occupants, and a preference associated with the occupants for a vehicle trip. The instructions include instructions to generate an interactive story and a driving environment that is virtual using a learning model from the sensor data, the contextual cue, and the preference. The instructions include instructions to adjust the interactive story and the driving environment with augmented information using the learning model for display within the vehicle upon a comparison result between a parameter of the interactive story and the driving environment and an engagement factor being unsatisfied,

In one embodiment, a method for generating and adjusting an interactive story about a driving environment using a learning model that factors trip features and an engagement factor is disclosed. In one embodiment, the method includes acquiring sensor data from a vehicle, a contextual cue about occupants, and a preference associated with the occupants for a vehicle trip. The method also includes generating an interactive story and a driving environment that is virtual using a learning model from the sensor data, the contextual cue, and the preference. The method also includes adjusting the interactive story and the driving environment with augmented information using the learning model for display within the vehicle upon a comparison result between a parameter of the interactive story and the driving environment and an engagement factor being unsatisfied.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one embodiment of a vehicle within which systems and methods disclosed herein may be implemented.

FIG. 2 illustrates one embodiment of an interactive system that is associated with generating and adjusting an interactive story about a driving environment using a learning model according to trip features and an engagement factor.

FIG. 3 illustrates an example of generating an interactive story and a driving environment using a learning model.

FIG. 4 illustrates the interactive system adjusting an interactive story and a driving environment with augmented information using the learning model.

FIG. 5 illustrates one embodiment of a method that is associated with generating an interactive story and a driving environment using a learning model from sensor data, a contextual cue, and a preference.

### DETAILED DESCRIPTION

Systems, methods, and other embodiments associated with generating and adjusting an interactive story about a driving environment using a learning model according to trip features and an engagement factor are disclosed herein. In various implementations, systems within a vehicle utilize entertainment for improving a vehicle trip that are mundane using environmental awareness that is customized. For example, an infotainment system customizes a music playlist for an occupant and adapts volume from road noise during the vehicle trip. Still, the infotainment system can have limited adaptation capabilities for personalization from using sparse and basic data (e.g., selection history). As such, an occupant can lose interest with the music playlist, thereby decreasing travel pleasure. Thus, systems adapting content for travel pleasure can lack customization that reduces occupant interest in the content.

Therefore, an interactive system includes a tool for content creation that is integrated within the vehicle that allows real-time access to sensor data, contextual cues about occupants, and available metadata for generating a virtual environment by a learning model. Here, a story mode of a vehicle dynamically transforms a vehicle trip that is mundane into a rich and interactive experience using a windshield display, an infotainment system, augmented reality (AR), etc. In one approach, the interactive system seamlessly blends real-world data, historical context, and preferences about a vehicle occupant to generate an interactive story including a personalized journey automatically using the learning model (e.g., a data-driven network, an attention-based transformer network, a generative artificial intelligence (GenAI) model, etc.). The interactive story can relate objects within the driving environment along a travel route of the vehicle to contextual cues (e.g., facial expressions, pointing, hand movement, etc.) and preferences that increases travel adventure.

In another approach, the personalized journey times critical points (e.g., story arcs) of the interactive story with stops, destination points, etc., of the vehicle trip for maintaining suspense and engagement from the occupants. Furthermore the learning model trains to generate the personalized journey through comparing generated features for the interactive story with actual features and adapting weights using computed losses. In this way, the interactive story makes the vehicle trip captivating and memorable for individuals traveling within a vehicle.

In various implementations, the interactive system monitors engagement and reconfigures and adapts the virtual scene during the story mode using occupant inputs (e.g., calendar data), changing geography, etc., to the learning model. For instance, the interactive system adjusts the interactive story with augmented information using the learning model by comparing a parameter of the interactive story and an engagement factor. Here, a parameter can be associated with a story plot, character, etc. The engagement factor can gauge interest in the parameter such as through biometrics, posture, etc. Accordingly, the interactive system generates narrative journeys that are personalized in real-time and continuously adapts the journey using live inputs from various sources, thereby ensuring a seamless and eventful experience during a vehicle trip.

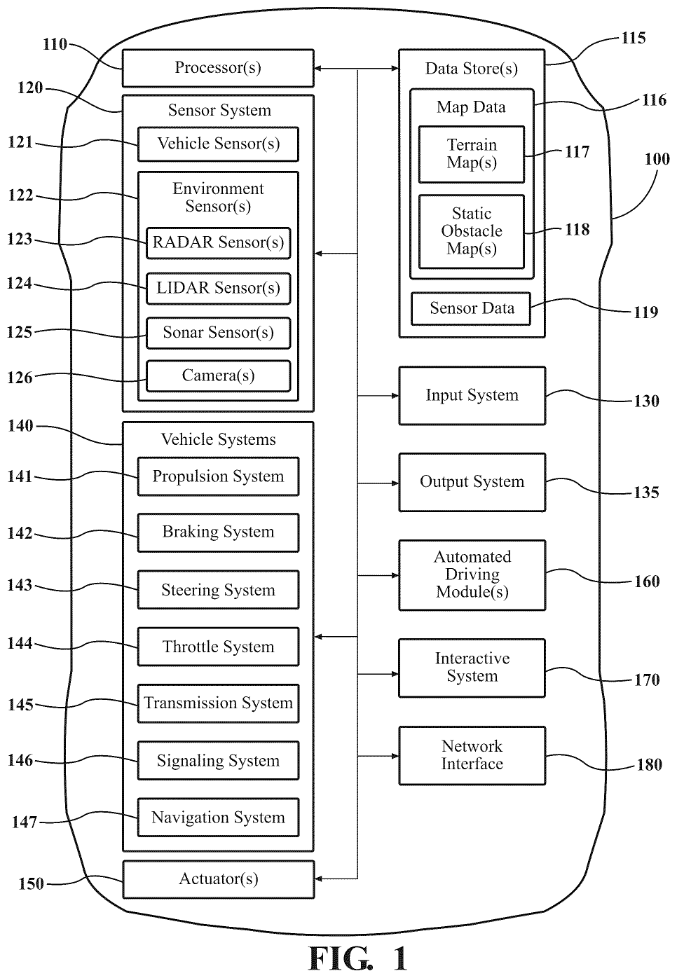

Referring to FIG. 1, an example of a vehicle 100 is illustrated. As used herein, a “vehicle” is any form of motorized transport. In one or more implementations, the vehicle 100 is an automobile. While arrangements will be described herein with respect to automobiles, it will be understood that embodiments are not limited to automobiles. In some implementations, an interactive system 170 uses road-side units (RSU), consumer electronics (CE), mobile devices, robots, drones, and so on that benefit from the functionality discussed herein associated with generating and adjusting an interactive story about a driving environment using a learning model according to trip features and an engagement factor.

The vehicle 100 also includes various elements. It will be understood that in various embodiments, the vehicle 100 may have less than the elements shown in FIG. 1. The vehicle 100 can have any combination of the various elements shown in FIG. 1. Furthermore, the vehicle 100 can have additional elements to those shown in FIG. 1. In some arrangements, the vehicle 100 may be implemented without one or more of the elements shown in FIG. 1. While the various elements are shown as being located within the vehicle 100 in FIG. 1, it will be understood that one or more of these elements can be located external to the vehicle 100. Furthermore, the elements shown may be physically separated by large distances. For example, as discussed, one or more components of the disclosed system can be implemented within a vehicle while further components of the system are implemented within a cloud-computing environment or other system that is remote from the vehicle 100 through communications using network interface 180.

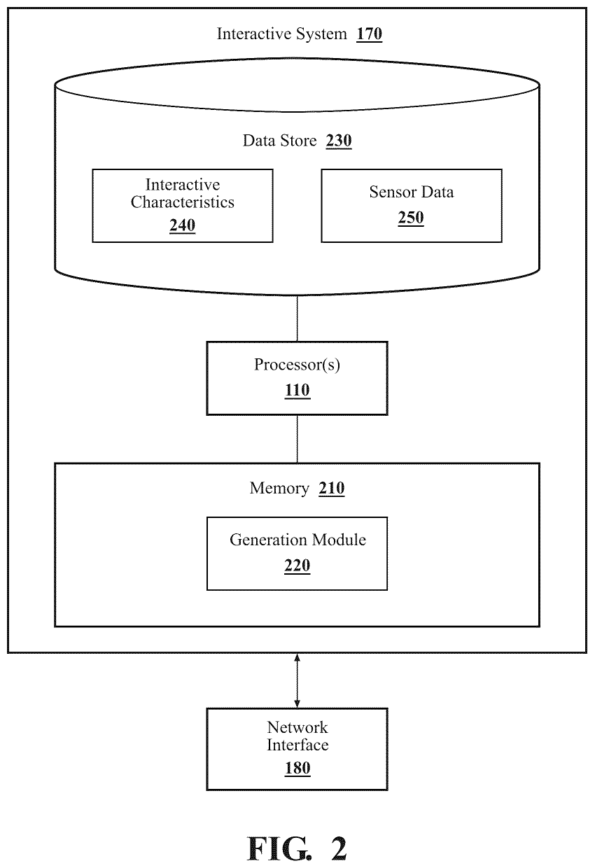

Some of the possible elements of the vehicle 100 are shown in FIG. 1 and will be described along with subsequent figures. However, a description of many of the elements in FIG. 1 will be provided after the discussion of FIGS. 2-5 for purposes of brevity of this description. Additionally, it will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements. In either case, the vehicle 100 includes an interactive system 170 that is implemented to perform methods and other functions as disclosed herein relating to improving generating and adjusting an interactive story about a driving environment using a learning model according to trip features and an engagement factor.

With reference to FIG. 2, one embodiment of the interactive system 170 of FIG. 1 is further illustrated. The interactive system 170 is shown as including a processor(s) 110 from the vehicle 100 of FIG. 1. Accordingly, the processor(s) 110 may be a part of the interactive system 170, the interactive system 170 may include a separate processor from the processor(s) 110 of the vehicle 100, or the interactive system 170 may access the processor(s) 110 through a data bus or another communication path. In one embodiment, the interactive system 170 includes a memory 210 that stores a generation module 220. The memory 210 is a random-access memory (RAM), a read-only memory (ROM), a hard-disk drive, a flash memory, or other suitable memory for storing the generation module 220. The generation module 220 is, for example, computer-readable instructions that when executed by the processor(s) 110 cause the processor(s) 110 to perform the various functions disclosed herein.

The interactive system 170 as illustrated in FIG. 2 is generally an abstracted form of the interactive system 170. Furthermore, the interactive system 170 and/or the generation module 220 generally includes instructions that function to control the processor(s) 110 to receive data inputs from one or more sensors of the vehicle 100. The inputs are, in one embodiment, observations of one or more objects in an environment proximate to the vehicle 100 and/or other aspects about the surroundings. As provided for herein, the generation module 220, in one embodiment, acquires sensor data 250 that includes at least camera images. In further arrangements, the interactive system 170 and/or the generation module 220 acquire the sensor data 250 from further sensors such as radar sensors 123, LIDAR sensors 124, and other sensors as may be suitable for identifying vehicles and locations of the vehicles.

Accordingly, the interactive system 170 and/or the generation module 220, in one embodiment, control the respective sensors to provide the data inputs in the form of the sensor data 250. Additionally, while the interactive system 170 and/or the generation module 220 are discussed as controlling the various sensors to provide the sensor data 250, in one or more embodiments, other techniques for acquiring the sensor data 250 include either active or passive approaches. For example, the interactive system 170 and/or the generation module 220 passively sniff the sensor data 250 from a stream of electronic information provided by the various sensors to further components within the vehicle 100. Moreover, an approach includes fusing data from multiple sensors when providing the sensor data 250 and/or from sensor data acquired over a wireless communication link. Thus, the sensor data 250, in one embodiment, represents a combination of perceptions acquired from multiple sensors.

In addition to locations of surrounding vehicles, the sensor data 250 includes, for example, information about lane markings, and so on. Moreover, the interactive system 170 and/or the generation module 220, in one embodiment, control the sensors to acquire the sensor data 250 about an area that encompasses 360 degrees about the vehicle 100 in order to provide a comprehensive assessment of the surrounding environment. Of course, in alternative embodiments, the sensor data 250 is acquired from a forward direction alone when, for example, the vehicle 100 is not equipped with further sensors to include additional regions about the vehicle and/or the additional regions are not scanned due to other reasons.

Moreover, in one embodiment, the interactive system 170 includes a data store 230. In one embodiment, the data store 230 is a database. The database is, in one embodiment, an electronic data structure stored in the memory 210 or another data store and that is configured with routines that can be executed by the processor(s) 110 for analyzing stored data, providing stored data, organizing stored data, and so on. Thus, in one embodiment, the data store 230 stores data used by the interactive system 170 and/or the generation module 220 in executing various functions. In one embodiment, the data store 230 includes the sensor data 250 along with, for example, metadata that characterize various aspects of the sensor data 250. For example, the metadata includes location coordinates (e.g., longitude and latitude), relative map coordinates or tile identifiers, time/date stamps from when the separate sensor data 250 was generated, and so on. The sensor data 250 can also include one of image data (e.g., photos, video, etc.) having landmarks, temperature information, precipitation information, geographical information, topographical information, and traffic data utilized by the interactive system 170 for generating an interactive story and a driving environment.

In one embodiment, the data store 230 further includes interactive characteristics 240 that is one of story tone, story pace, story type (e.g., fiction, historical, current events, geographical, etc.), a preference about occupants within the vehicle 100, a parameter of an interactive story, and an engagement factor. Here, in one approach, the interactive system 170 derives the preference from one of a social media profile about the occupants, a social network, and a story type selected by the occupants. For example, a preference is a story length that includes one of a word count, a time duration, a chapter count, and a page count. Furthermore, the parameter can be one of a length of the interactive story and a theme of the driving environment. The engagement factor can be one of focus information, seating posture, and biometric features associated with the occupants.

The interactive system 170, in one embodiment, accesses cloud services for generating and maintaining an interactive story and a driving environment. For example, the vehicle 100 connects to a cloud service for real-time data processing, updates, and storage of a preference about occupants using the network interface 180 (e.g., a local area network (LAN) or a wide area network (WAN), a wireless network, a wired network, etc.).

In various implementations, the interactive system 170 is further configured to perform additional tasks beyond controlling the respective sensors to acquire and provide the sensor data 250. For example, the interactive system 170 and/or the generation module 220 include instructions that cause the processor 110 to acquire the sensor data 250 from the vehicle 100, a contextual cue about occupants, and a preference associated with the occupants for a vehicle trip. In one approach, the generation module 220 generates an interactive story and a driving environment that is virtual using a learning model from the sensor data 250, the contextual cue, and the preference. This can involve the learning model outputting suggested topics for the interactive story according to recently related stories, a current geographical area, prompt responses, etc. The interactive story can relate to scenery, towns, landmarks, etc., of the driving environment along a route involving the vehicle 100 that is incorporated into a story in real-time for presentation through output system 135. Furthermore, the interaction system 170 can adjust the interactive story and the driving environment with augmented information using the learning model for display within the vehicle 100 upon a comparison between a parameter of the interactive story and the driving environment to an engagement factor.

In various embodiments, the learning model is one of a data-driven network, a neural network (NN), a convolutional NN (CNN), and an attention-based transformer network that can function as a GenAI engine. For example, a NN performs semantic segmentation over the sensor data 250 from which further information is derived. Of course, in further aspects, the interactive system 170 may employ different machine learning algorithms or implements different approaches for performing the associated functions, which can include deep convolutional encoder-decoder architectures, or another suitable approach that generates semantic labels for the separate object classes represented in the image. Whichever approach, the learning model can output semantic labels identifying objects represented in the sensor data 250 for generating an interactive story and a driving environment.

Moreover, the interactive system 170 can train the learning model by comparing generated features for an interactive story and the driving environment with actual features. For instance, the actual feature can be ground truth data, or information about the interactive story generated by a data simulator for training. Furthermore, the interactive system 170 computes losses between the generated features and the actual features. The learning model adapts weights using the losses to improve performance associated with engagement and interest by vehicle occupants.

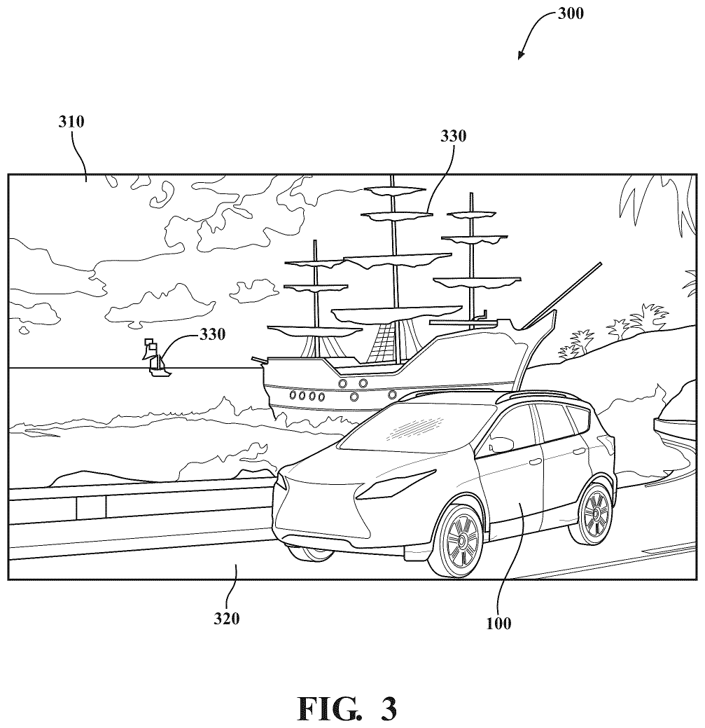

Now turning to FIG. 3, an example of generating an interactive story for a driving environment 310 using a learning model within a virtual environment 300 is illustrated. Here, the vehicle 100 is traveling on the road 320 and enters a story mode. The learning model (e.g., a GenAI model) generates the interactive story and the driving environment 310, having coherent and engaging plotlines from various inputs captured by the interactive characteristics 240 and the sensor data 250. For example, the interactive system 170 injects multiple arcs into the interactive story involving a multi-stop trip for the vehicle 100. A segment can represent a stop and an arc for the stop can occur upon the segment ending, thereby leaving occupants in suspense.

A trip involving multiple stops can include a first segment to a school followed by a second segment to a shopping mall. The first segment includes traveling with a superhero virtually during a narrated story. Meanwhile, the interactive system 170 introduces a villain virtually with narration for the second segment. Furthermore, the narration about the superhero and the villain can adapt to a travel period including traffic of the first segment and the second segment estimated by the navigation system 147. Similarly, a segment can be associated with various travels scheduled during a time period (e.g., month, week, etc.) such that a segment corresponds with a chapter of the interactive story. In this way, the interactive story stops at a good point when a trip segment ends.

In various implementations, the learning model maintains logical consistency and emotional resonance using one of natural language processing (NLP), data fusion in real-time, and interactions with the occupants throughout the interactive story. The NLP can understand and respond to occupant inputs for crafting dialogue and descriptions about the interactive story and the driving environment 310 that are natural and engaging. For instance, the NLP has a voice recognition engine that recognizes different occupants within the vehicle 100 such that an occupant can specify interests, such as genres (e.g., fantasy, mystery, historical fiction, etc.) and themes (e.g., adventure, romance, family-friendly, etc.) for the interactive story. In this way, the learning model can learn and relate individual preferences over time, customize stories for a vehicle trip, etc.

Moreover, data fusion can continuously integrate data from a global position system (GPS) sensor of one or more vehicle sensors 121, one or more cameras 126, etc., and update a narrative context as the driving environment 310 changes, thereby ensuring that the interactive story remains relevant and immersive. For instance, the interactive system 170 identifies points having historical and local lore (e.g., Gettysburg battles, ghost stories in New Orleans, etc.) along a travel route using the navigation system 147. This can include myths, folklore, significant events, etc., associated with different locations during a vehicle trip that enriches storytelling. The historical and local lore are integrated into the driving environment 310 along with a generated interactive story personalized for different occupants within the vehicle 100. Furthermore, the interactions allow occupants to choose and change a story direction, thereby increasing interactivity. For example, a user interface accessible through an infotainment system of the vehicle 100 allows voice commands, touchscreen controls, etc., to alter the vehicle trip from ocean-side having historic ships 330 on choppy waters to viewing modern yachts.

As previously explained, the interactive story can have segments associated with one of a chapter and a page. For example, a segment is a leg from a multiple-stop trip involving the vehicle 100 and the segment adapts image data (e.g., photos, video, etc.) for augmenting a virtual scene and the driving environment 310 surrounding the vehicle 100. A chapter or page can also be associated with a complete trip so that the occupant leaves the interactive story at a natural transition point. This also allows the interactive system 170 to change chapter, page, etc., content for various trip times upcoming, such as by following calendar dates.

An image can be acquired from the one or more cameras 126 and altered using the generation module 220 to create “Pages and Chapters” that add depth for the story mode, thereby improving occupant interest with a plot. In another approach, the generation module 220 and the learning model incorporate landmarks, landscapes, weather conditions, etc., into the interactive story in real-time as imagery adaptation. The interactive story can also adapt contextually from changes surroundings the vehicle 100, such as entering a forest, passing a lake, approaching a historic site, etc.

The interactive system 170 can also acquire traffic data about a road segment on the road 320 from other vehicles using the network interface 180. For instance, the other vehicles are traveling on the road segment associated with a stop of a multi-stop trip currently being taken by the vehicle 100. The interactive system 170 and/or generation module can project the vehicle 100 within the interactive story on a display and sound system of the output system 135 using the traffic data from the other vehicles. The display may be a rear-seat display, a transparent display on a windshield, a heads-up display (HUD), an infotainment display, etc. For example, the other vehicles indicate an accident ahead on the road 320 and the interactive system 170 generates a humorous story through the output system 135 that lessens the cognitive load for traveling through an accident scene. In this way, the interactive system 170 generates content involving a future encounter of the vehicle 100 anticipated by the occupant, thereby increasing interest and engagement.

Adapting the interactive story can involve comparing a parameter of the interactive story and a driving environment 310 to an engagement factor as follows. Here, the parameter can be associated with a story plot, character, tone, pace, a length of the interactive story, a theme of the driving environment, etc. In one approach, the interactive system 170 derives a contextual cue about one or more occupants using a biometric model. For instance, the biometric model tracks one of a visual, a facial, voice quality, pointing, arm movement, etc., for adaptations from data acquired with the sensor system 120 and the sensor data 250. The biometric model can identify distinct keypoints (e.g., a nose, a mouth, etc.) in an image acquired with one or more cameras 126 and audible information from a microphone and track biometric qualities using predictions outputted by a machine learning (ML) model. As such, the learning model can estimate engagement and emotional responses with the interactive story by the occupants using the contextual cue and related biometric features.

Adjusting the interactive story and the driving environment 310 can involve the interactive system 170 detecting a decrease in the engagement and waning interest (e.g., boredom) automatically using the learning model. As such, the generation module 220 can alter a feature within a segment of the interactive story and the driving environment 310 in real-time for increasing the engagement. The feature can be changing one of a tone, pace, humor, a plot twist for the interactive story, and characters (e.g., adding a character) to the driving environment 310. The segment can be associated with a stop during the vehicle trip. For example, the interactive system 170 introduces humorous moments associated with points-of-interest (POI) along a route during a boring segment, suspense during moments of low engagement, etc., for increasing interest. In this way, the interactive system 170 maintains enjoyment and interaction with the interactive story during the vehicle trip through adapting the feature.

In one embodiment, the learning model integrates driving data about a trip acquired from local and remote data sources (e.g., a Google search, cloud system, etc.) using the network interface 180. The local source can be an on-board library stored in the data store 230. For instance, the learning model adjusts pace and complexity of the interactive story according to a length of a vehicle trip. Furthermore, integrating route information such as stops and detours allows the interactive system 170 to weave relevant plot points and settings into the interactive story. For example, the generation module 220 adapts segments involving the interactive story and weights for visual settings of the driving environment 310 according to planned stops associated with the vehicle trip. Here, the segments can differ among occupants within the vehicle 100 for focused and robust customization. Altering end points of the segments using inputs from the occupants can also increase personalization. In another approach, customization includes the interactive system 170 automatically generating a podcast for different occupants about the vehicle trip. This can involve using a user-selected topic and information. An enhanced feature includes editing the podcast interactively in real-time when the vehicle trip changes, such as from traffic, detours, etc.

In various implementations, the vehicle 100 includes specific modes for story mode. A family or friend mode allows members close to an occupant control and influence over the interactive story for the driving environment 310. Here, interactive choices from the members collaborating can alter plots, subplots, etc., to encourage participation from occupants, thereby increasing interest and engagement. For instance, a choice customizes personalities for a virtual character describing a monument along the road 320 that enriches the travel experience. In one approach, a family embarks on a quest such that a family member plays a different role and makes choices that affect the direction of the interactive story. In this way, the occupant learns and experiences regions that the vehicle 100 passes differently for personalization.

Other specific modes can include a couple mode and a solo mode. The couple mode can include generating an interactive story that is romantic, adventurous, etc., using interests of the couple and context about the vehicle trip. A narrative can intertwine with scenery and historical context of a destination within the driving environment 310. In another embodiment, solo mode outputs deeply immersive, personalized stories that are individualized for occupants, such as detailed murder mysteries, introspective adventures, etc. In this way, solo travelers can indulge in gripping narratives through solving a murder mystery that evolves as the vehicle 100 passes town. The narrative can also involve exploring a personal journey of discovery for a landscape associated with the driving environment 310.

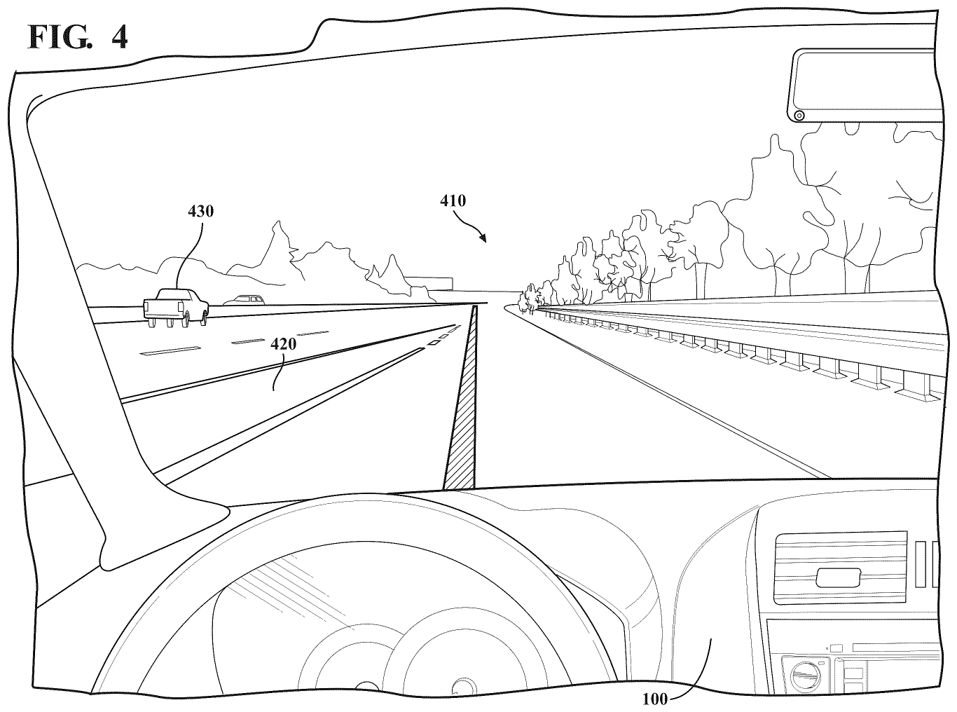

Regarding FIG. 4, the interactive system 170 can adjust an interactive story and a driving environment 410 with augmented information using the learning model. Here, the vehicle 100 is merging onto a road 420 that includes a pickup truck 430. The interactive system 170 and the generation module 220 integrated within the vehicle 100 can generate and output the interactive story and the driving environment 410. In an example, a learning model (e.g., a GenAI model) generates the interactive story and the driving environment 410 from the sensor data 250 and a contextual cue. A display and a sound system of the output system 135 present the interactive story and the driving environment 410. In one approach, the display is a rear-seat display, a transparent display on a windshield, a HUD, an infotainment display, etc. In this way, a content creation tool integrated within the vehicle 100 improves a vehicle trip through enriching sights and sounds along a route.

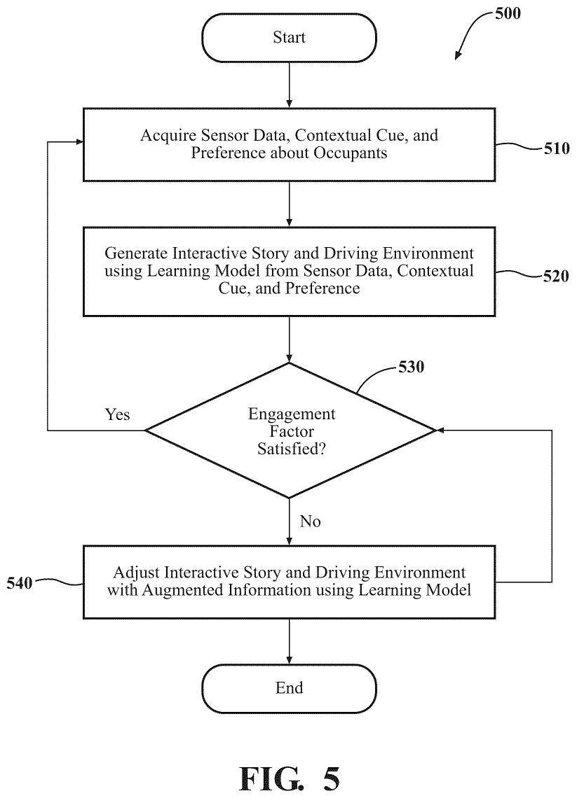

Turning to FIG. 5, one embodiment of a method 500 that is associated with generating an interactive story and a driving environment using the learning model from the sensor data 250, a contextual cue, and a preference is illustrated. The method 500 will be discussed from the perspective of the interactive system 170 of FIGS. 1 and 2. While the method 500 is discussed in combination with the interactive system 170, it should be appreciated that the method 500 is not limited to being implemented within the interactive system 170 but is instead one example of a system that may implement the method 500.

At 510, the interactive system 170 acquires the sensor data 250, a contextual cue, and a preference about occupants for the vehicle 100. Here, a contextual cue and a preference may be inputs that the interactive system 170 can utilize to develop an interactive story. In particular, the interactive story can relate objects within the driving environment along a travel route for increasing travel pleasure during a vehicle trip. As previously described, the interactive system 170 can derive the contextual cue about one or more occupants using a biometric model that tracks a visual, facial, voice quality, pointing, arm movement, etc. In this way, a learning model can estimate interest from engagement and emotional responses with the interactive story by the occupants using the contextual cue. Furthermore, the interactive system 170 can derive the preference from various sources and inputs. These sources include one of a social media profile about the occupants, a social network, and a story type inputted by the occupants. As such, a derived preference can be a story length (e.g., a word count, a time duration, a chapter count, a page count, etc.), genre, character types (e.g., superheroes), etc.

At 520, the generation module 220 generates an interactive story and a driving environment using a learning model from the sensor data 250, the contextual cue, and the preference. The generation module 220 can form the interactive story having virtual characters and scenery that follow a plot personalized for a vehicle trip and an occupant using the sensor data 250, the contextual cue, and the preference. Furthermore, for example, the interactive system 170 identifies points having historical and local significance along a travel route. This can include myths, folklore, significant events, etc., associated with different POI that can enrich the interactive story.

Moreover, the interactive system 170 allows an occupant to choose a direction of the virtual story dynamically during the vehicle trip for increasing interactivity. For instance, an infotainment system of the vehicle 100 allows voice commands, touchscreen controls, etc., to alter the vehicle trip. In various implementations, the interactive story has segments for dividing a plot into a chapter, a page, etc., corresponding with nuances of the vehicle tip. For example, a segment is a leg of a multiple-stop trip by the vehicle 100 and the segment adapts image data (e.g., photos, video, etc.) for augmenting a virtual scene and the driving environment surrounding the vehicle 100. In another approach, the chapter, the page, etc., is associated with a complete trip so that the occupant leaves the interactive story at a natural transition point. As previously explained, the transition point can correspond with planned trips listed on various calendars of the one or more occupants for exact timing.

In various implementations, the learning model uses the network interface 180 for integrating driving data about a trip acquired from remote data sources (e.g., a Google search, cloud system, etc.). For instance, the learning model adjusts the pace and complexity of the interactive story according to a length of the vehicle trip using local and remote data sources. Furthermore, integrating route information such as stops allows the interactive system 170 to weave relevant plot points and settings into the interactive story.

At 530, the interactive system 170 measures the satisfaction of an engagement factor. Here, in one approach, the engagement factor gauges occupant interest with the interactive story using a parameter. The parameter can be associated with a story plot, character, etc., associated with the interactive story. In another example, the learning model estimates decreasing engagement and waning interest (e.g., boredom) associated with the interactive story using the contextual cue and the sensor data 250 and outputs the engagement factor. Comparing the parameter to the engagement factor indicates interest and a need to adjust the interactive story for maintaining the occupant interest. As such, the interactive system 170 acquires additional information about the sensor data 250, contextual cues and preferences about one or more occupants when the engagement factor is satisfactory.

At 540, the interactive system 170 adjusts the interactive story and the driving environment with augmented information automatically using the learning model when the engagement factor is unsatisfactory. In one approach, the interactive system 170 and the generation module 220 alter a feature within a segment of the interactive story and the driving environment in real-time. For instance, the feature is one of a tone, pace, humor, and a plot twist for the interactive story to the driving environment 310. This can include adding a character that the interactive system 170 identifies as likely drawing the attention of an occupant using the sensor data 250, the contextual cue, and the preference. Concerning interest improvements, the interactive system 170 introduces a humorous or suspenseful moment associated with a POI along a route during a segment that the occupant finds repetitive.

Adaptation by the interactive system 170 can also include weighing visual settings of the driving environment according to planned stops associated with the vehicle trip. For instance, the interactive system 170 morphs segments on an occupant basis within the vehicle 100 for increasing the engagement factor. Altering end points of the segments using inputs from the occupants can also increase the engagement factor through improving personalization. Furthermore, the interactive system 170 continues adapting the interactive story through changing features until satisfying the engagement factor. Accordingly, an interactive story adapts for maintaining an engagement factor that is satisfactory using the interactive system 170 during the vehicle trip through changing the feature, thereby generating an exciting experience.

FIG. 1 will now be discussed in full detail as an example environment within which the system and methods disclosed herein may operate. In some instances, the vehicle 100 is configured to switch selectively between different modes of operation/control according to the direction of one or more modules/systems of the vehicle 100. In one approach, the modes include: 0, no automation; 1, driver assistance; 2, partial automation; 3, conditional automation; 4, high automation; and 5, full automation. In one or more arrangements, the vehicle 100 can be configured to operate in a subset of possible modes.

In one or more embodiments, the vehicle 100 is an automated or autonomous vehicle. As used herein, “autonomous vehicle” refers to a vehicle that is capable of operating in an autonomous mode (e.g., category 5, full automation). “Automated mode” or “autonomous mode” refers to navigating and/or maneuvering the vehicle 100 along a travel route using one or more computing systems to control the vehicle 100 with minimal or no input from a human driver. In one or more embodiments, the vehicle 100 is highly automated or completely automated. In one embodiment, the vehicle 100 is configured with one or more semi-autonomous operational modes in which one or more computing systems perform a portion of the navigation and/or maneuvering of the vehicle along a travel route, and a vehicle operator (i.e., driver) provides inputs to the vehicle to perform a portion of the navigation and/or maneuvering of the vehicle 100 along a travel route.

The vehicle 100 can include one or more processors 110. In one or more arrangements, the processor(s) 110 can be a main processor of the vehicle 100. For instance, the processor(s) 110 can be an electronic control unit (ECU), an application-specific integrated circuit (ASIC), a microprocessor, etc. The vehicle 100 can include one or more data stores 115 for storing one or more types of data. The data store(s) 115 can include volatile and/or non-volatile memory. Examples of suitable data stores 115 include RAM, flash memory, ROM, programmable read-only memory (PROM), erasable programmable read-only memory (EPROM), electrically erasable programmable read-only memory (EEPROM), registers, magnetic disks, optical disks, and hard drives. The data store(s) 115 can be a component of the processor(s) 110, or the data store(s) 115 can be operatively connected to the processor(s) 110 for use thereby. The term “operatively connected,” as used throughout this description, can include direct or indirect connections, including connections without direct physical contact.

In one or more arrangements, the one or more data stores 115 can include map data 116. The map data 116 can include maps of one or more geographic areas. In some instances, the map data 116 can include information or data on roads, traffic control devices, road markings, structures, features, and/or landmarks in the one or more geographic areas. The map data 116 can be in any suitable form. In some instances, the map data 116 can include aerial views of an area. In some instances, the map data 116 can include ground views of an area, including 360-degree ground views. The map data 116 can include measurements, dimensions, distances, and/or information for one or more items included in the map data 116 and/or relative to other items included in the map data 116. The map data 116 can include a digital map with information about road geometry.

In one or more arrangements, the map data 116 can include one or more terrain maps 117. The terrain map(s) 117 can include information about the terrain, roads, surfaces, and/or other features of one or more geographic areas. The terrain map(s) 117 can include elevation data in the one or more geographic areas. The terrain map(s) 117 can define one or more ground surfaces, which can include paved roads, unpaved roads, land, and other things that define a ground surface.

In one or more arrangements, the map data 116 can include one or more static obstacle maps 118. The static obstacle map(s) 118 can include information about one or more static obstacles located within one or more geographic areas. A “static obstacle” is a physical object whose position does not change or substantially change over a period of time and/or whose size does not change or substantially change over a period of time. Examples of static obstacles can include trees, buildings, curbs, fences, railings, medians, utility poles, statues, monuments, signs, benches, furniture, mailboxes, large rocks, or hills. The static obstacles can be objects that extend above ground level. The one or more static obstacles included in the static obstacle map(s) 118 can have location data, size data, dimension data, material data, and/or other data associated with it. The static obstacle map(s) 118 can include measurements, dimensions, distances, and/or information for one or more static obstacles. The static obstacle map(s) 118 can be high quality and/or highly detailed. The static obstacle map(s) 118 can be updated to reflect changes within a mapped area.

One or more data stores 115 can include sensor data 119. In this context, “sensor data” means any information about the sensors that the vehicle 100 is equipped with, including the capabilities and other information about such sensors. As will be explained below, the vehicle 100 can include the sensor system 120. The sensor data 119 can relate to one or more sensors of the sensor system 120. As an example, in one or more arrangements, the sensor data 119 can include information about one or more LIDAR sensors 124 of the sensor system 120.

In some instances, at least a portion of the map data 116 and/or the sensor data 119 can be located in one or more data stores 115 located onboard the vehicle 100. Alternatively, or in addition, at least a portion of the map data 116 and/or the sensor data 119 can be located in one or more data stores 115 that are located remotely from the vehicle 100.

As noted above, the vehicle 100 can include the sensor system 120. The sensor system 120 can include one or more sensors. “Sensor” means a device that can detect, and/or sense something. In at least one embodiment, the one or more sensors detect, and/or sense in real-time. As used herein, the term “real-time” means a level of processing responsiveness that a user or system senses as sufficiently immediate for a particular process or determination to be made, or that enables the processor to keep up with some external process.

In arrangements in which the sensor system 120 includes a plurality of sensors, the sensors may function independently or two or more of the sensors may function in combination. The sensor system 120 and/or the one or more sensors can be operatively connected to the processor(s) 110, the data store(s) 115, and/or another element of the vehicle 100. The sensor system 120 can produce observations about a portion of the environment of the vehicle 100 (e.g., nearby vehicles).

The sensor system 120 can include any suitable type of sensor. Various examples of different types of sensors will be described herein. However, it will be understood that the embodiments are not limited to the particular sensors described. The sensor system 120 can include one or more vehicle sensors 121. The vehicle sensor(s) 121 can detect information about the vehicle 100 itself. In one or more arrangements, the vehicle sensor(s) 121 can be configured to detect position and orientation changes of the vehicle 100, such as, for example, based on inertial acceleration. In one or more arrangements, the vehicle sensor(s) 121 can include one or more accelerometers, one or more gyroscopes, an inertial measurement unit (IMU), a dead-reckoning system, a global navigation satellite system (GNSS), a GPS, a navigation system 147, and/or other suitable sensors. The vehicle sensor(s) 121 can be configured to detect one or more characteristics of the vehicle 100 and/or a manner in which the vehicle 100 is operating. In one or more arrangements, the vehicle sensor(s) 121 can include a speedometer to determine a current speed of the vehicle 100.

Alternatively, or in addition, the sensor system 120 can include one or more environment sensors 122 configured to acquire data about an environment surrounding the vehicle 100 in which the vehicle 100 is operating. “Surrounding environment data” includes data about the external environment in which the vehicle is located or one or more portions thereof. For example, the one or more environment sensors 122 can be configured to sense obstacles in at least a portion of the external environment of the vehicle 100 and/or data about such obstacles. Such obstacles may be stationary objects and/or dynamic objects. The one or more environment sensors 122 can be configured to detect other things in the external environment of the vehicle 100, such as, for example, lane markers, signs, traffic lights, traffic signs, lane lines, crosswalks, curbs proximate to the vehicle 100, off-road objects, etc.

Various examples of sensors of the sensor system 120 will be described herein. The example sensors may be part of the one or more environment sensors 122 and/or the one or more vehicle sensors 121. However, it will be understood that the embodiments are not limited to the particular sensors described.

As an example, in one or more arrangements, the sensor system 120 can include one or more of: radar sensors 123, LIDAR sensors 124, sonar sensors 125, weather sensors, haptic sensors, locational sensors, and/or the one or more cameras 126. In one or more arrangements, the one or more cameras 126 can be high dynamic range (HDR) cameras, stereo, or infrared (IR) cameras.

The vehicle 100 can include an input system 130. An “input system” includes components or arrangement or groups thereof that enable various entities to enter data into a machine. The input system 130 can receive an input from a vehicle occupant. The vehicle 100 can include an output system 135. An “output system” includes one or more components that facilitate presenting data to a vehicle occupant.

The vehicle 100 can include one or more vehicle systems 140. Various examples of the one or more vehicle systems 140 are shown in FIG. 1. However, the vehicle 100 can include more, fewer, or different vehicle systems. It should be appreciated that although particular vehicle systems are separately defined, any of the systems or portions thereof may be otherwise combined or segregated via hardware and/or software within the vehicle 100. The vehicle 100 can include a propulsion system 141, a braking system 142, a steering system 143, a throttle system 144, a transmission system 145, a signaling system 146, and/or a navigation system 147. Any of these systems can include one or more devices, components, and/or a combination thereof, now known or later developed.

The navigation system 147 can include one or more devices, applications, and/or combinations thereof, now known or later developed, configured to determine the geographic location of the vehicle 100 and/or to determine a travel route for the vehicle 100. The navigation system 147 can include one or more mapping applications to determine a travel route for the vehicle 100. The navigation system 147 can include a global positioning system, a local positioning system, or a geolocation system.

The processor(s) 110, the interactive system 170, and/or the automated driving module(s) 160 can be operatively connected to communicate with the various vehicle systems 140 and/or individual components thereof. For example, the processor(s) 110 and/or the automated driving module(s) 160 can be in communication to send and/or receive information from the various vehicle systems 140 to control the movement of the vehicle 100. The processor(s) 110, the interactive system 170, and/or the automated driving module(s) 160 may control some or all of the vehicle systems 140 and, thus, may be partially or fully autonomous as defined by the society of automotive engineers (SAE) levels 0 to 5.

The processor(s) 110, the interactive system 170, and/or the automated driving module(s) 160 can be operatively connected to communicate with the various vehicle systems 140 and/or individual components thereof. For example, the processor(s) 110, the interactive system 170, and/or the automated driving module(s) 160 can be in communication to send and/or receive information from the various vehicle systems 140 to control the movement of the vehicle 100. The processor(s) 110, the interactive system 170, and/or the automated driving module(s) 160 may control some or all of the vehicle systems 140.

The processor(s) 110, the interactive system 170, and/or the automated driving module(s) 160 may be operable to control the navigation and maneuvering of the vehicle 100 by controlling one or more of the vehicle systems 140 and/or components thereof. For instance, when operating in an autonomous mode, the processor(s) 110, the interactive system 170, and/or the automated driving module(s) 160 can control the direction and/or speed of the vehicle 100. The processor(s) 110, the interactive system 170, and/or the automated driving module(s) 160 can cause the vehicle 100 to accelerate, decelerate, and/or change direction. As used herein, “cause” or “causing” means to make, force, compel, direct, command, instruct, and/or enable an event or action to occur or at least be in a state where such event or action may occur, either in a direct or indirect manner.

The vehicle 100 can include one or more actuators 150. The actuators 150 can be an element or a combination of elements operable to alter one or more of the vehicle systems 140 or components thereof responsive to receiving signals or other inputs from the processor(s) 110 and/or the automated driving module(s) 160. For instance, the one or more actuators 150 can include motors, pneumatic actuators, hydraulic pistons, relays, solenoids, and/or piezoelectric actuators, just to name a few possibilities.

The vehicle 100 can include one or more modules, at least some of which are described herein. The modules can be implemented as computer-readable program code that, when executed by a processor(s) 110, implement one or more of the various processes described herein. One or more of the modules can be a component of the processor(s) 110, or one or more of the modules can be executed on and/or distributed among other processing systems to which the processor(s) 110 is operatively connected. The modules can include instructions (e.g., program logic) executable by one or more processors 110. Alternatively, or in addition, one or more data stores 115 may contain such instructions.

In one or more arrangements, one or more of the modules described herein can include artificial intelligence elements, e.g., neural network, fuzzy logic, or other machine learning algorithms. Furthermore, in one or more arrangements, one or more of the modules can be distributed among a plurality of the modules described herein. In one or more arrangements, two or more of the modules described herein can be combined into a single module.

The vehicle 100 can include one or more automated driving modules 160. The automated driving module(s) 160 can be configured to receive data from the sensor system 120 and/or any other type of system capable of capturing information relating to the vehicle 100 and/or the external environment of the vehicle 100. In one or more arrangements, the automated driving module(s) 160 can use such data to generate one or more driving scene models. The automated driving module(s) 160 can determine position and velocity of the vehicle 100. The automated driving module(s) 160 can determine the location of obstacles, obstacles, or other environmental features including traffic signs, trees, shrubs, neighboring vehicles, pedestrians, etc.

The automated driving module(s) 160 can be configured to receive, and/or determine location information for obstacles within the external environment of the vehicle 100 for use by the processor(s) 110, and/or one or more of the modules described herein to estimate position and orientation of the vehicle 100, vehicle position in global coordinates based on signals from a plurality of satellites, or any other data and/or signals that could be used to determine the current state of the vehicle 100 or determine the position of the vehicle 100 with respect to its environment for use in either creating a map or determining the position of the vehicle 100 in respect to map data.

The automated driving module(s) 160 either independently or in combination with the interactive system 170 can be configured to determine travel path(s), current autonomous driving maneuvers for the vehicle 100, future autonomous driving maneuvers and/or modifications to current autonomous driving maneuvers based on data acquired by the sensor system 120, driving scene models, and/or data from any other suitable source such as determinations from the sensor data 250. “Driving maneuver” means one or more actions that affect the movement of a vehicle. Examples of driving maneuvers include: accelerating, decelerating, braking, turning, moving in a lateral direction of the vehicle 100, changing travel lanes, merging into a travel lane, and/or reversing, just to name a few possibilities. The automated driving module(s) 160 can be configured to implement determined driving maneuvers. The automated driving module(s) 160 can cause, directly or indirectly, such autonomous driving maneuvers to be implemented. As used herein, “cause” or “causing” means to make, command, instruct, and/or enable an event or action to occur or at least be in a state where such event or action may occur, either in a direct or indirect manner. The automated driving module(s) 160 can be configured to execute various vehicle functions and/or to transmit data to, receive data from, interact with, and/or control the vehicle 100 or one or more systems thereof (e.g., one or more of vehicle systems 140).

Detailed embodiments are disclosed herein. However, it is to be understood that the disclosed embodiments are intended as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Furthermore, the terms and phrases used herein are not intended to be limiting but rather to provide an understandable description of possible implementations. Various embodiments are shown in FIGS. 1-5, but the embodiments are not limited to the illustrated structure or application.

The flowcharts and block diagrams in the figures illustrate the architecture, functionality, and operation of possible implementations of systems, methods, and computer program products according to various embodiments. In this regard, a block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components, and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein.

The systems, components, and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a ROM, an EPROM or flash memory, a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

Generally, modules as used herein include routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an ASIC, a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, radio frequency (RF), etc., or any suitable combination of the foregoing. Computer program code for carrying out operations for aspects of the present arrangements may be written in any combination of one or more programming languages, including an object-oriented programming language such as Java™, Smalltalk™, C++, or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a LAN or a WAN, or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all combinations of one or more of the associated listed items. As an example, the phrase “at least one of A, B, and C” includes A, B, C, or any combination thereof (e.g., AB, AC, BC, or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. An interactive system comprising:
a memory storing instructions that, when executed by a processor, cause the processor to:
acquire sensor data from a vehicle, a contextual cue about occupants, and a preference associated with the occupants for a vehicle trip;
generate an interactive story and a driving environment that is virtual using a learning model from the sensor data, the contextual cue, and the preference; and
upon a comparison result between a parameter of the interactive story and the driving environment and an engagement factor being unsatisfied, adjust the interactive story and the driving environment with augmented information using the learning model for display within the vehicle.

2. The interactive system of claim 1, wherein the instructions to compare the parameter further include instructions to:
derive the contextual cue using a biometric model that tracks one of a visual, a facial, and a voice quality associated with the occupants; and
estimate engagement with the interactive story by the occupants using the contextual cue by the learning model.

3. The interactive system of claim 2, wherein the instructions to adjust the interactive story and the driving environment further include instructions to:
detect a decrease in the engagement by the learning model; and
alter a feature within a segment of the interactive story and the driving environment to increase the engagement, wherein the feature is one of a tone, a pace, humor, a plot twist for the interactive story, and adding a character to the driving environment, and the segment is associated with a stop during the vehicle trip.

4. The interactive system of claim 3, wherein the segment is associated with one of a chapter and a page of the interactive story and the segment is associated with an image about a scene surrounding the vehicle.

5. The interactive system of claim 1 further including instructions to:
compare generated features for the interactive story and the driving environment using the learning model with actual features during training;
compute losses between the generated features and the actual features; and
adapt weights of the learning model using the losses.

6. The interactive system of claim 1 further including instructions to:
adapt segments of the interactive story and weights for visual settings of the driving environment according to planned stops associated with the vehicle trip, wherein the segments differ among the occupants; and
alter end points of the segments using inputs from the occupants.

7. The interactive system of claim 1 further including instructions to:
receive traffic data by the vehicle about a road segment on the vehicle trip from other vehicles traveling on the road segment; and
project the vehicle within the interactive story on the display using the traffic data.

8. The interactive system of claim 1, wherein:
the sensor data is one of an image including landmarks, outdoor temperature, precipitation information, geographical information, topographical information, and traffic data;
the preference is derived from one of a social media profile about the occupants and a story type selected by the occupants;
the parameter is one of a length of the interactive story and a theme of the driving environment; and
the engagement factor is one of focus information and a seating posture associated with the occupants.

9. The interactive system of claim 1, wherein the learning model is one of a data-driven network, a neural network (NN), a convolutional NN (CNN), and an attention-based transformer network.

10. A non-transitory computer-readable medium comprising:
instructions that when executed by a processor cause the processor to:
acquire sensor data from a vehicle, a contextual cue about occupants, and a preference associated with the occupants for a vehicle trip;
generate an interactive story and a driving environment that is virtual using a learning model from the sensor data, the contextual cue, and the preference; and
upon a comparison result between a parameter of the interactive story and the driving environment and an engagement factor being unsatisfied, adjust the interactive story and the driving environment with augmented information using the learning model for display within the vehicle.

11. The non-transitory computer-readable medium of claim 10, wherein the instructions to compare the parameter further include instructions to:
derive the contextual cue using a biometric model that tracks one of a visual, a facial, and a voice quality associated with the occupants; and
estimate engagement with the interactive story by the occupants using the contextual cue by the learning model.

12. A method comprising:
acquiring sensor data from a vehicle, a contextual cue about occupants, and a preference associated with the occupants for a vehicle trip;
generating an interactive story and a driving environment that is virtual using a learning model from the sensor data, the contextual cue, and the preference; and
upon a comparison result between a parameter of the interactive story and the driving environment and an engagement factor being unsatisfied, adjusting the interactive story and the driving environment with augmented information using the learning model for display within the vehicle.

13. The method of claim 12, wherein comparing the parameter further includes:
deriving the contextual cue using a biometric model that tracks one of a visual, a facial, and a voice quality associated with the occupants; and
estimating engagement with the interactive story by the occupants using the contextual cue by the learning model.

14. The method of claim 13, wherein adjusting the interactive story and the driving environment further includes:
detecting a decrease in the engagement by the learning model; and
altering a feature within a segment of the interactive story and the driving environment to increase the engagement, wherein the feature is one of a tone, a pace, humor, a plot twist for the interactive story, and adding a character to the driving environment, and the segment is associated with a stop during the vehicle trip.

15. The method of claim 14, wherein the segment is associated with one of a chapter and a page of the interactive story and the segment is associated with an image about a scene surrounding the vehicle.

16. The method of claim 12 further comprising:
comparing generated features for the interactive story and the driving environment using the learning model with actual features during training;
computing losses between the generated features and the actual features; and
adapting weights of the learning model using the losses.

17. The method of claim 12 further comprising:
adapting segments of the interactive story and weights for visual settings of the driving environment according to planned stops associated with the vehicle trip, wherein the segments differ among the occupants; and
altering end points of the segments using inputs from the occupants.

18. The method of claim 12 further comprising:
receiving traffic data by the vehicle about a road segment on the vehicle trip from other vehicles traveling on the road segment; and
projecting the vehicle within the interactive story on the display using the traffic data.

19. The method of claim 12, wherein:
the sensor data is one of an image including landmarks, outdoor temperature, precipitation information, geographical information, topographical information, and traffic data;
the preference is derived from one of a social media profile about the occupants and a story type selected by the occupants;
the parameter is one of a length of the interactive story and a theme of the driving environment; and
the engagement factor is one of focus information and a seating posture associated with the occupants.

20. The method of claim 12, wherein the learning model is one of a data-driven network, a neural network (NN), a convolutional NN (CNN), and an attention-based transformer network.
